(19) United States
(12) Patent Application Publication
(10) Pub. No.: US 2012/0106000 A1
(43) Pub. Date: May 3, 2012

(54) HEAD POSITION CONTROL METHOD AND DISK DEVICE

(75) Inventors: Shuya Nosaki, Chigasaki (JP); Takenori Atsumi, Yamato (JP)

(73) Assignee: HITACHI, LTD., Tokyo (JP)

(21) Appl. No.: 13/266,524

(22) PCT Filed: Apr. 2, 2010
(86) PCT No.: PCT/JP2010/002421

§ 371 Date: Jan. 6, 2012

(30) Foreign Application Priority Data
Apr. 27, 2009 (JP) 2009-107287

(51) Int. Cl. G11B 21/02

(52) U.S. Cl. 360/75; G9B/21.003

(57) ABSTRACT

A track locus drawn on a disk discretely contains repeatable runout (RRO) components which are large in amplitude up to high-frequency band. In order to position a magnetic head along the track locus using filters good at suppressing RRO with resonance characteristics only at an integral multiple of a rotation frequency, many filters are required and thus it takes a long time for all the filters to go into a steady state. After learning until the filers go into a steady state, output values of the filters in a steady state are stored on a disk or in a memory. According to controlling the magnet head using these stored output values, the time required for the filters to go into a steady state becomes unnecessary.

### TECHNICAL FIELD

The present invention relates to a method for controlling a head position over a recording medium which requires to suppress all repeatable runout (RRO) by means of control and also relates to a disk device.

### BACKGROUND ART

In recent years, the use application of a hard disk drive (HDD) is expanding to cover not only the IT field such as enterprise servers and PCs, but also the consumer electronics field such as DVD recorders and portable music players. With this trend, demands for a larger-capacity and lower-price HDD are also becoming higher.

In order to realize such larger-capacity and lower-price HDD, higher surface recording density is necessary. For the higher surface recording density, it is effective to miniaturize magnetic grains which are the minimum units of magnetization reversal in order to make the signal-to-noise ratio (SNR) higher. However, because of such magnetic grain miniaturization, the thermal demagnetization problem that the recorded magnetization information of magnetic grains is lost due to thermal fluctuations becomes significant.

Further, there is writing fringe as the problem for higher surface recording density, which is unsolvable only by the magnetic grains miniaturization. The writing fringe is the following phenomenon: a recording magnetic field created from the main magnetic pole of a recording element interferes with neighboring recording tracks and erases information that has already been recorded. A high noise region under this influence is called an “erase band”. Usually, by taking into consideration the erase band, the track pitch is designed so that neighboring tracks do not interfere with each other.

The surface recording density of HDD is determined by the track pitch and the bit length, and thus, in order to achieve the higher surface recording density, it is indispensable to narrow the track pitch and shorten the bit length. Currently, a measure to lessen the erase band is to make steeper the gradient of a recording magnetic field or to control the exchange-coupling between magnetic grains. However, it is still impossible to exclude the erase band in the currently available media with the track pitch being magnetically determined by the width of main magnetic pole of recording elements.

In view of this, patterned media are proposed as an approach for drastically solving this problem. The patterned media denote magnetic recording media with neighboring recording tracks being physically and magnetically separated from each other by removing a magnetic film between recording tracks and/or between bits.

On the patterned media, there exist regions where magnetic film is removed as stated above, and thus the recording head is required to overlie a region where there is a magnetic film, always at time of magnetic recording. In other words, unlike conventional media, it is necessary to suppress all repeatable runout (RRO) from a low frequency band to a high frequency band by means of control.

As the above scheme for suppressing RRO components, Patent Literature 1 discloses a means for using a peak filter to remove RRO components in a frequency band of 1 kHz or less. Patent Literatures 2 and 3 disclose a means for removing RRO components of an entire frequency band by means of feedforward control. Patent Literature 4 discloses a means for removing RRO component by means of feedback control using a resonance filter.

### CITATION LIST

### Patent Literatures

### Patent Literature 1: JP-A-H10-027442

### Patent Literature 2: JP-A-H11-126444

### Patent Literature 3: JP-A-H11-039814

### Patent Literature 4: JP-A-2006-048770

### SUMMARY OF INVENTION

### Technical Problem

However, when removing RRO components of a high frequency band by using the peak filter as disclosed in Patent Literature 1, a vector locus of open-loop transfer characteristics comes close to (−1, 0). Due to this, the control system becomes unstable.

The feedforward control as disclosed in Patent Literatures 2 and 3 requires the modeling of a controlled object, Fourier transformation and Fourier series expansion in order to obtain controlled values for removing the RRO. Modeling a controlled object and computing Fourier transform or else cause errors such as modeling errors and quantization errors.

When removing RRO within a wide range from a low frequency band to a high frequency band, the above errors are accumulated, and thus RRO components cannot be removed completely. Further, the aforesaid errors also become the cause of an increase in non-repeatable runout (NRRO) components.

The resonance filter disclosed in Patent Literature 4 is considered to be effective in removing RRO components with the above features. The resonance filter is guaranteed control stability, and thus the above problem as occurred in Patent Literature 1 does not occur even in the process of removing RRO components in the high frequency band. However, it takes a long time for the resonance filter to go into a steady state where the RRO components can be completely removed. Although Patent Literature 4 discloses feedback control using resonance filters, it takes a long time for all resonance filters to go into a steady state because it is necessary as stated above to remove RRO from a low frequency band to a high frequency band. Further, it is required to equip a great number of resonance filters because a single filter is able to remove only one RRO component. These factors cause performance deterioration of the hard disk drive.

### Solution to Problem

The present invention proposes a hard disk drive comprising a process of learning an output value in a steady state of a resonance filter and a process of storing the output value learned.

### Advantageous Effects of Invention

According to the present invention, the time required for a resonance filter to go into a steady state becomes unnecessary. Further, since the resonance filter is needed only for the learning process, the filter becomes unnecessary after completion of the learning process. These enable to completely remove RRO with the above features and to avoid the risk of performance degradation of the HDD.

### BRIEF DESCRIPTION OF DRAWINGS

FIG. 1 A configuration diagram of a hard disk drive.

FIG. 2 A configuration diagram of a patterned media.

FIG. 3 A cross-sectional diagram of the patterned media.

FIG. 4 A method of manufacturing the patterned media.

FIG. 5 A configuration diagram of a servo pattern.

FIG. 6 A frequency spectrum of RRO of pre-pattern servo.

FIG. 7 A block diagram of a feedback circuit using a resonance filter.

FIG. 8 A flow diagram of RRO compensation of this embodiment 1.

FIG. 9 A diagram showing a change in frequency spectrum of PES in accordance with the present invention.

FIG. 10 A diagram showing time response of PES in accordance with the present invention.

FIG. 11 A diagram showing time response of RRO in accordance with the present invention.

FIG. 12 A diagram showing time response of NRRO in accordance with the present invention.

FIG. 13 A diagram showing effects of the present invention.

### DESCRIPTION OF EMBODIMENTS

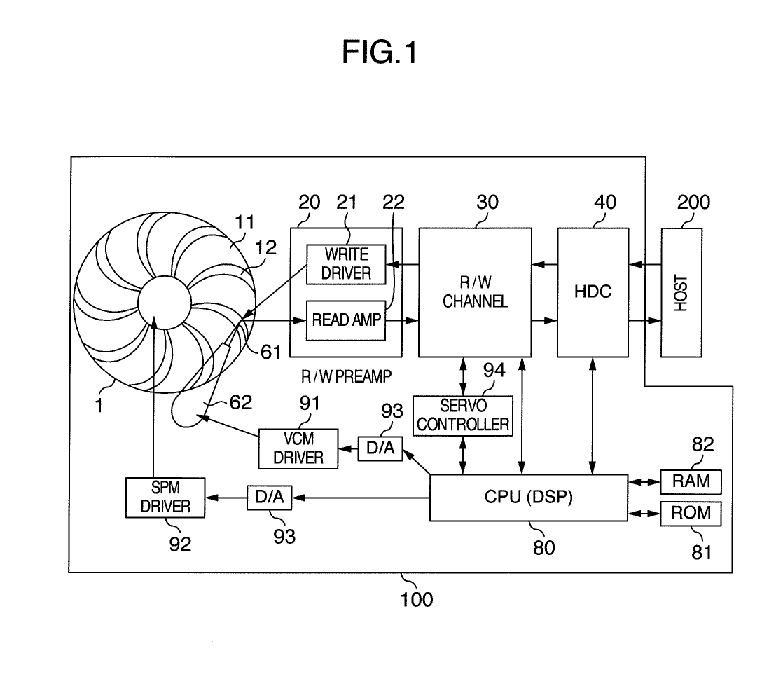

FIG. 1 shows a configuration diagram of a hard disk drive (HDD) 100, which is one example of the disk device. When receiving a write command and a write destination address from a host computer 50 at a hard disk controller (HDC) 40, the HDD 100 reads from a servo area 12 via a read/write preamplifier 20 a servo data processed by a read/write channel to know a present position of a magnetic head 61, and adjusts a current value to be input to a voice coil motor (VCM) 62 in response to the present position of the magnetic head 61 to move the magnetic head 61 to a target position (target address) and to record/reproduce user data in a user data area 11. A VCM driver 91 drives and controls the VCM 62 by giving a VCM operation amount designated from a central processing unit (CPU (DSP)) 80 as the current value. A spindle motor (SPM) driver 92 drives and controls it so that its rotation speed remains a constant speed given from the CPU 80. A digital signal to be given from the CPU 80 during these operations is converted by a digital-to-analog converter (D/A) 93 into an analog signal. A servo controller 94 performs processing for reading a servo signal to obtain address information such as sectors and tracks as well as an off-track amount between the center of a data area and the head position.

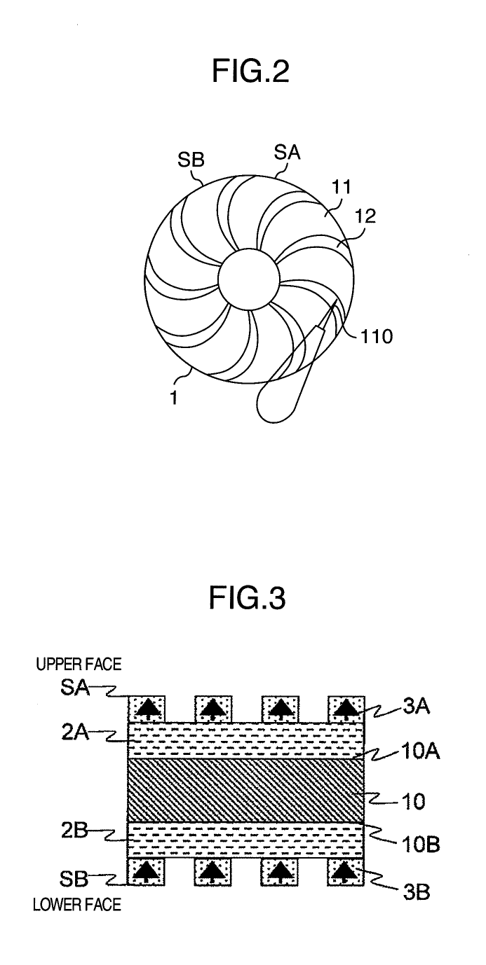

FIG. 2 schematically shows a top plan view of the pattern arrangement of a patterned recording medium 1 used in both sided perpendicular magnetic recording in accordance with one embodiment of the present invention. The patterned recording medium (patterned media) 1 has two faces, i.e., an upper face SA and a lower face SB, and is rotated by the spindle motor. As shown in FIG. 2, the face SA of the patterned recording medium 1 comprises user data areas 11 for recording user data, and servo areas 12 consisting of positioning signals, track numbers, sector numbers, etc. The servo areas 12 are formed in an arc in radial directions of the patterned recording medium 1 and at equal intervals in a circumferential direction of the recording medium 1. When using the patterned recording medium 1 built in the hard disk drive 100, an arc corresponds to a locus where the magnetic head 61 within the device moves while floating over the patterned recording medium 1. A length of each servo area 11 is formed so that its length along the circumferential direction of the patterned recording medium 1 is in proportion to a radius position of the recording medium 1. Also on the face SB of the patterned recording medium 1, the user data areas 11 and servo areas 12 are formed similarly to the face SA of patterned recording medium 1. The servo areas 12 on the face SA and servo areas 12′ on the face SB are mirror-symmetrically arranged.

As shown in FIG. 3, the patterned recording medium 1 includes a flat substrate 10 having two faces 10A and 10B. On respective faces 10A and 10B of the substrate 10, underlayers 2A and 2B are formed, each of which includes a soft underlayer (SUL) and an interlayer. On top surfaces of these underlayers 2A and 2B, recording layers 3A and 3B are formed. Up arrows “↑” depicted in the patterned recording layers 3A and 3B on the patterned recording medium 1 indicate the internal magnetization directions of the recording layers 3A and 3B. After having produced the patterned recording medium 1, they are magnetized in the direction of the arrows “↑” shown in FIG. 3 by performing magnetization processing. Here, the recording layers 3A and 3B are magnetized so that a leading end of the arrow “↑” becomes N (north) pole whereas a base end thereof becomes S (south) pole.

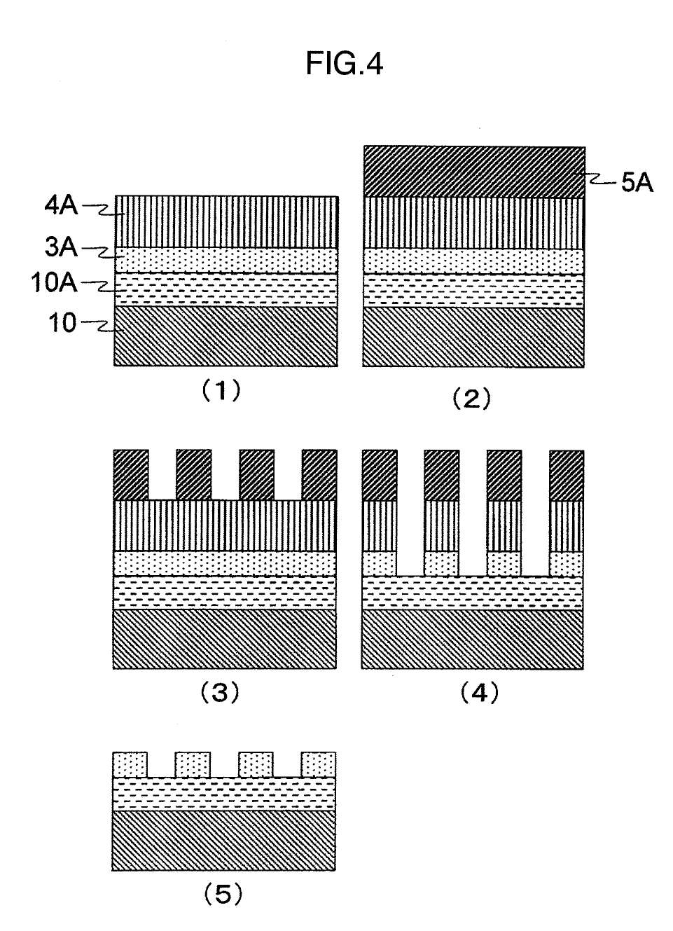

Although an explanation will be given below as to the face SA of the patterned recording medium 1, the same goes for the face SB. FIG. 4 is a cross-section diagram of the patterned recording medium 1 comprising these pattern areas in the process showing one example of a method of manufacturing the patterned recording medium 1. Firstly, in order to process the recording layer 3A into a designed pattern by using ion milling, reactive ion etching, etc., a mask layer 4A is formed on the recording layer 3A (at Step (1)). Next, in order to process the mask layer 4A into a designed pattern by using laser exposure, electron beam lithography, nano-imprint techniques, etc., a resist 5A is formed on the mask layer 4A (at Step (2)). Then, the resist 5A and the mask layer 4A and the recording layer 3A are processed using suitable processing techniques into the designed pattern (at Steps (3) and (4)). Finally, stripping and cleaning techniques are used to remove the resist 5A and the mask layer 4A and other residual materials which are no longer necessary (at Step (5)).

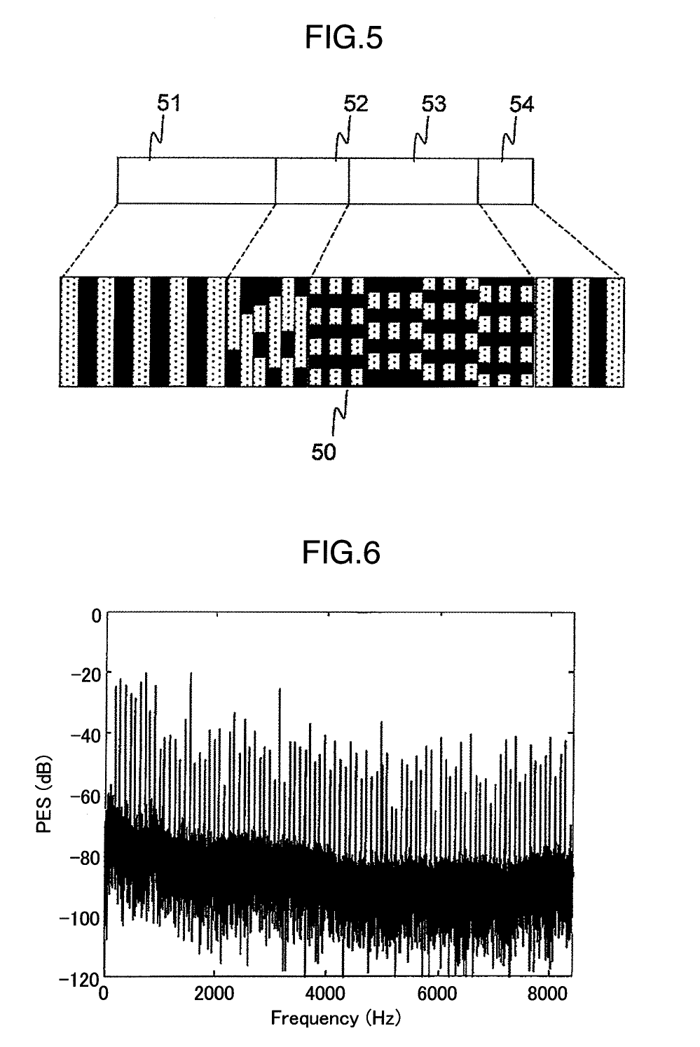

FIG. 5 shows configuration of a servo area 12 of the patterned recording medium 1 manufactured in this way. The pattern of the servo area 12 shown in FIG. 2 indicates a pattern on the face SA side of the patterned recording medium 1 built in the magnetic disk device in cases where the magnetic head 61 within the drive travels from the left side to right side of the drawing. As shown in FIG. 5, a servo pattern 50 consists of a preamble part 51, an address part 52, a burst part 53 and a postamble part 54. The preamble part 51 is a portion for establishing synchronization during playback of the servo pattern 50. The address part 52 is a portion for storing the position information of a target track. The burst part 53 is a portion for recording the center of the target track. The postamble part 54 is a portion for indicating the end of the servo pattern 50.

On the recording layer 3A of the patterned recording medium 1 processed by using the electron beam lithography or else as stated above, a region where the recording layer 3A exists and a region where it does not are mixed in a user data area 11. In other words, there are a region which can record user data and a region which cannot record them. Accordingly, when recording user data, the magnetic head 61 is required to locate in the magnetically recordable region always without fail.

FIG. 6 shows a frequency spectrum of a position error signal (PES) indicative of an error between the target value of the patterned recording medium 1 and the actual head position. A repeatable runout (RRO) synchronized with the rotation exists only at a integral multiple of a sampling frequency and is shown by a line spectrum. As seen from FIG. 6, large-amplitude RRO components are scattered up to a high frequency such as 5000 Hz. As stated previously, in the patterned recording medium 1, the magnetic head 61 should be driven to follow up a magnetically recordable region, and thus it is required to perform such control as to enable the magnetic head 61 to exhibit perfectly follow up RRO components with these features.

### EMBODIMENT 1

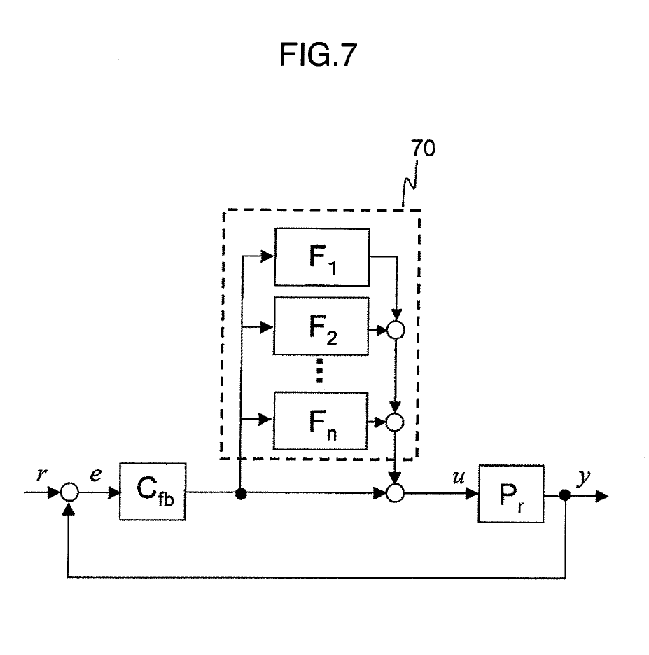

FIG. 7 shows a block diagram of a feedback control circuit using a resonance filter 70 in this embodiment. A symbol r shown in FIG. 7 is a target value (a target position of a head); e is PES, C_{fb} is a servo controller; u is an input current value to a controlled object; Pr is VCM which is the controlled object; and, y is a current position of the head.

The resonance filter 70 has filters F₁ to Fₙ with resonance characteristics only at a integral multiple of a rotation frequency of a disk 1 and is a head positioning control system with the vector locus of open-loop transfer characteristics at such frequency going in a direction away from (−1, 0). So, it is more stable in a high frequency band than an ordinary peak filter. The central processing unit (CPU (DSP)) 80 which performs digital signal processing operates to initially set up the order of an RRO to be suppressed. Then, while repeating PES measurement using the feedback control circuit shown in FIG. 7, the DSP 80 calculates internal state variables of respective filters F₁ to Fₙ to which the order of RRO to be suppressed was set up to make the filters F₁ to Fₙ go into a steady state. As a result, a constant output value can stably suppress the RRO being set up.

It should be noted that although the explanation was given while denoting the unit 70 as the resonance filter and F₁ to Fₙ as filters in order to avoid confusion, respective ones of these filters F₁ to Fₙ are also resonance filters. Consequently, in a case where there is only one filter F, the filter F₁ per se is the resonance filter 70. In a case where there are a plurality of filters F, it can also be said that the resonance filter 70 is a resonance filter group comprising a plurality of resonance filters.

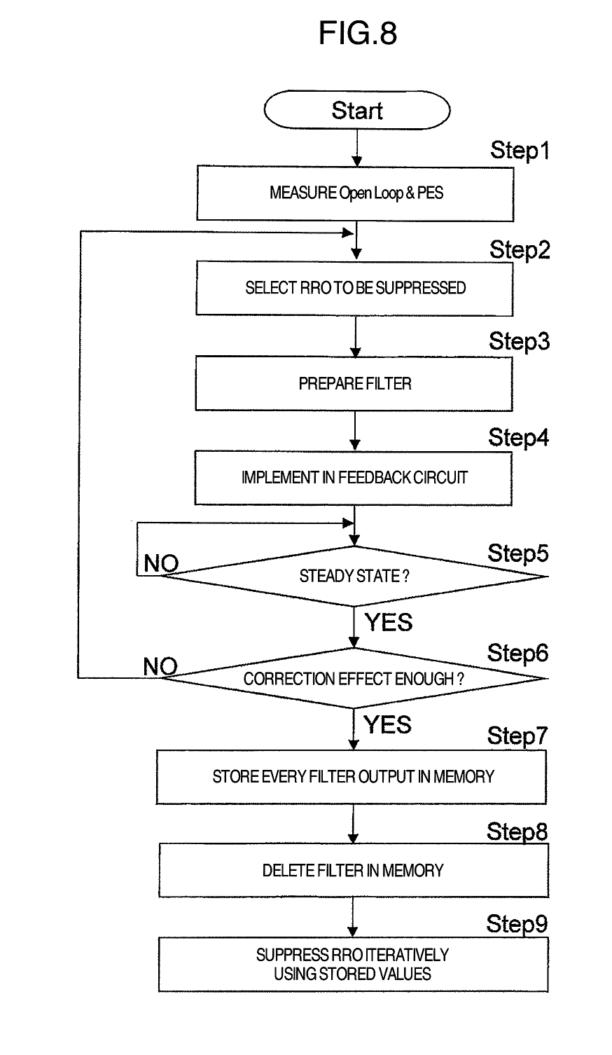

FIG. 8 shows a flow diagram of the embodiment. At Step 1, the DSP 80 imports burst data A, B, C and D of the burst part 53 in the servo pattern 50 shown in FIG. 5. Then, it computes PES using the burst data A, B, C and D in accordance with an arithmetic expression prestored in a read-only memory (ROM) 81. In addition, the DSP 80 imports an output signal from a specific input signal and calculates a frequency response in accordance with an analysis program prestored in the ROM 81.

Subsequently, at Step 2, the DSP 80 decides from this frequency response a region where there is no resonance of the magnetic head 61, VCM 62, etc. in accordance with a threshold value stored in the ROM 81. In such frequency region, the DSP 80 sequentially selects a large-amplitude RRO components from the frequency spectrum of PES. Then, at Step 3, the DSP 80 sets up and stores in the HDC 40 a filer corresponding to the selected RRO component.

In Step 4, a program, which becomes a feedback control circuit for the resonance filter stored in HDC 40 between the servo controller C_{f} and the controlled object Pr such as the magnetic head 61 or VCM 62, is prestored in the ROM 81 and, when the DSP 80 performs following, it reads from the ROM 81 this program and executes the same.

At Step 5, the DSP 80 repeats the calculation until the internal state variable of a filter being set up goes into a steady state. The DSP 80 judges that the filter is in a steady state when either the PES or the input current value to the VCM 62 falls within an arbitrary variation range prestored in the ROM 81 during an arbitrary cycle prestored in the ROM 81. Subsequently, at Step 6, the DSP 80 decides whether or not the PES prestored in the ROM 81 stays within its target range. In a case where the PES does not stay within its target range, the DSP 80 increases the number of filters to be used, alters the priority order of RRO components to be suppressed in the process of determining the RRO components to be suppressed, etc. in accordance with the program in the ROM 81. Thereafter, the DSP 80 repeats the arithmetic processing through similar processes until the PES falls within its target range.

At Step 7, the DSP 80 stores in the random access memory (RAM) 82 an output of the resonance filter 70 obtained when the PES is its target value. At this time, from a position at which the DSP 80 adds the outputs of all the filters in order to store outputs of all the filters being set up, the DSP 80 extracts output values and stores them in the RAM 82. Further, the region in the RAM 82 for storing such values stores only the number of values equivalent to a least common multiple of the orders of respective filters implemented. The least common multiple of the orders of respective filters is calculated at the DSP 80 when setting up respective filters; a region for storing the number of values equivalent to the least common multiple of the orders is provided in the RAM 82; then, the DSP 80 stores therein output values of the resonance filter 70. At Step 8, the DSP 80 releases all the resonance filters being set up. The RAM 82 is preferably a nonvolatile memory in order to store the outputs of the resonance filter. It should be noted that they may also be recorded on the patterned recording medium 1 rather than in the RAM 82 and be read from the patterned recording medium 1 or that they may also be recorded on the patterned recording medium 1 and be read therefrom into the RAM 82 as necessary.

When seeking to any track, at Step 9, the DSP 80 iteratively uses as a correction value the value stored in the RAM 82 at Step 7 to suppress RRO and perform following.

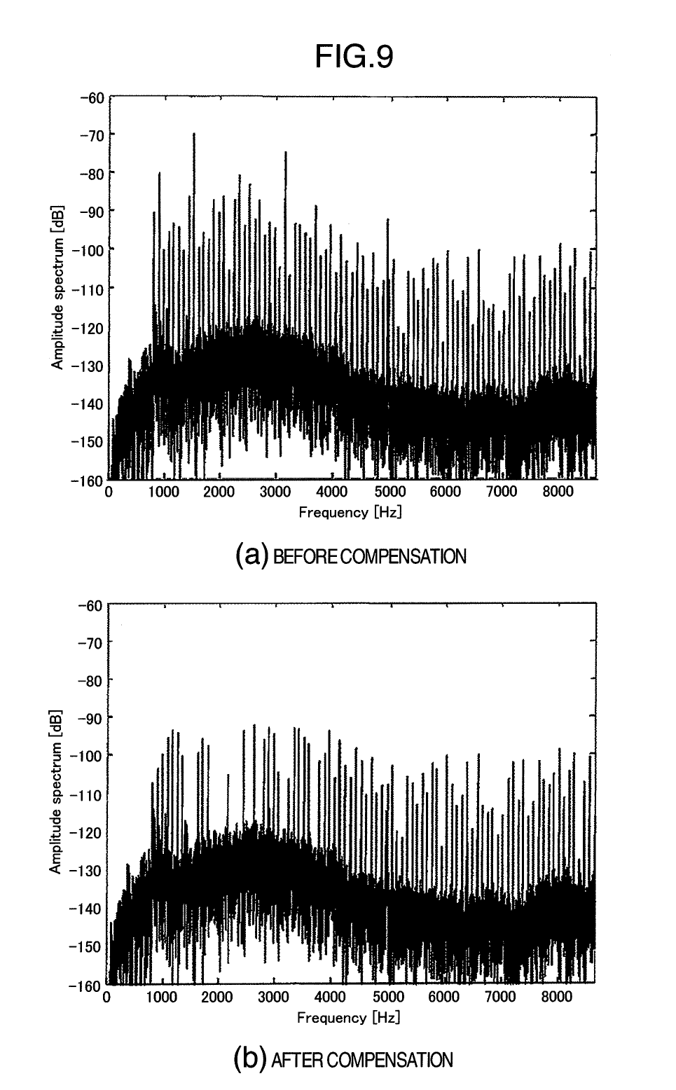

As one example, it is a target to make the PES with large-amplitude line spectra shown in FIG. 9 being scattered up to a high frequency components fall within a range of ±25 nm. In order to provide a control system capable of reaching this target, 14 components with amplitude spectrum being greater than or equal to −90 dB are selected from the PES's line spectra as shown in FIG. 9. Filters F₁ to F₁₄ corresponding to these 14 components are prepared, and then the DSP 80 repeats the arithmetic processing until the internal state variables of respective filters F₁ to F₁₄ go into a steady state. And, the random access memory (RAM) 82 stores the number of outputs equivalent to a least common multiple of the orders of these resonance filters F₁ to F₁₄ in a steady state.

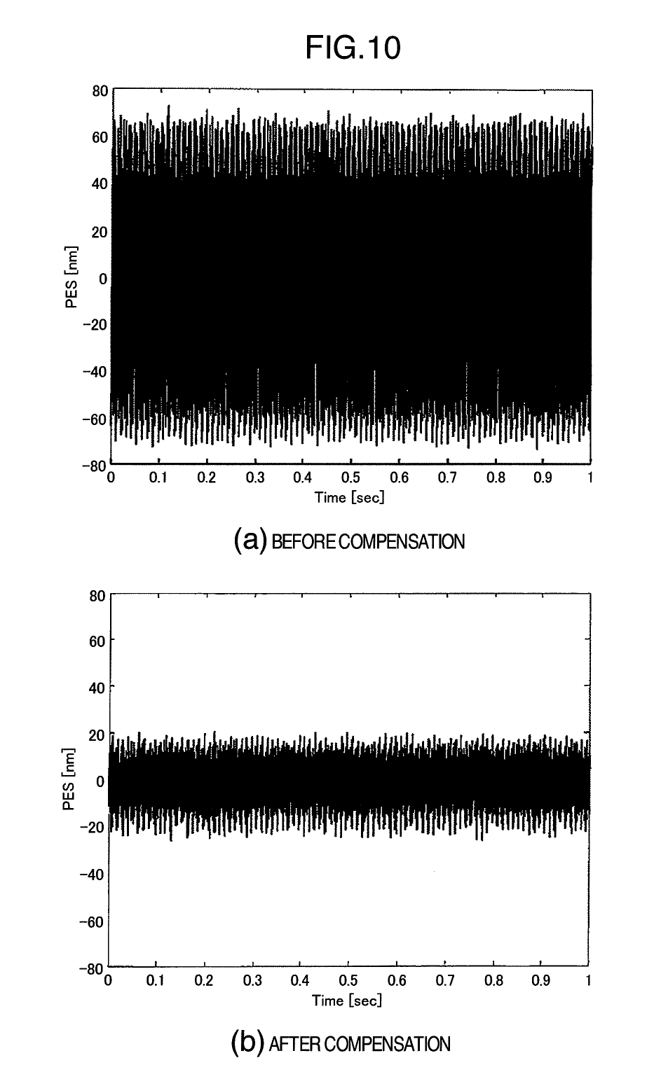

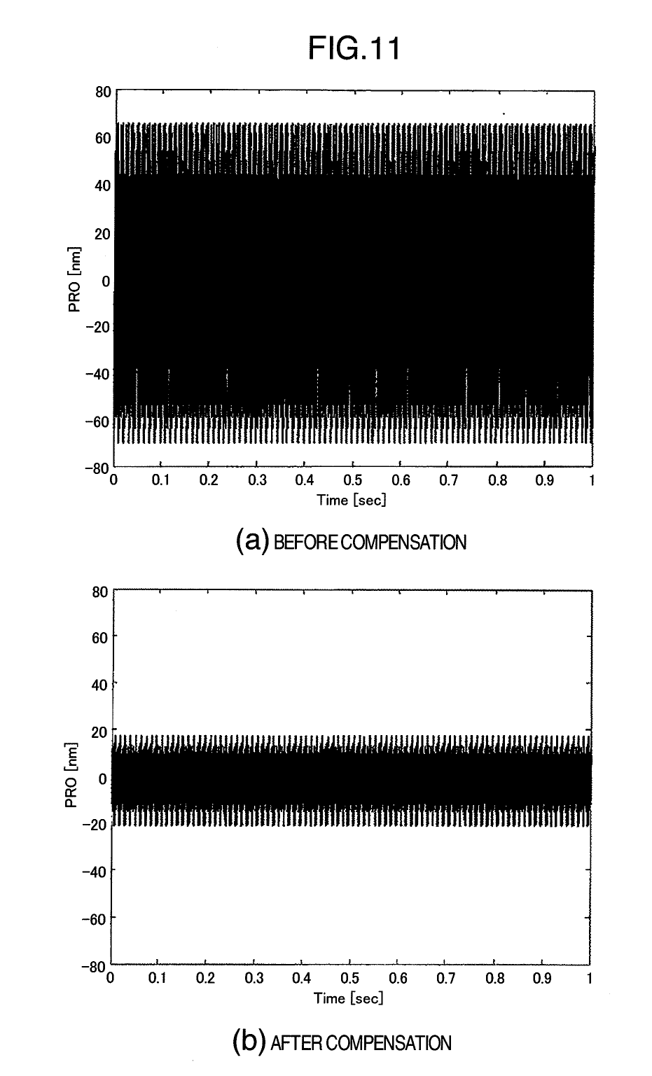

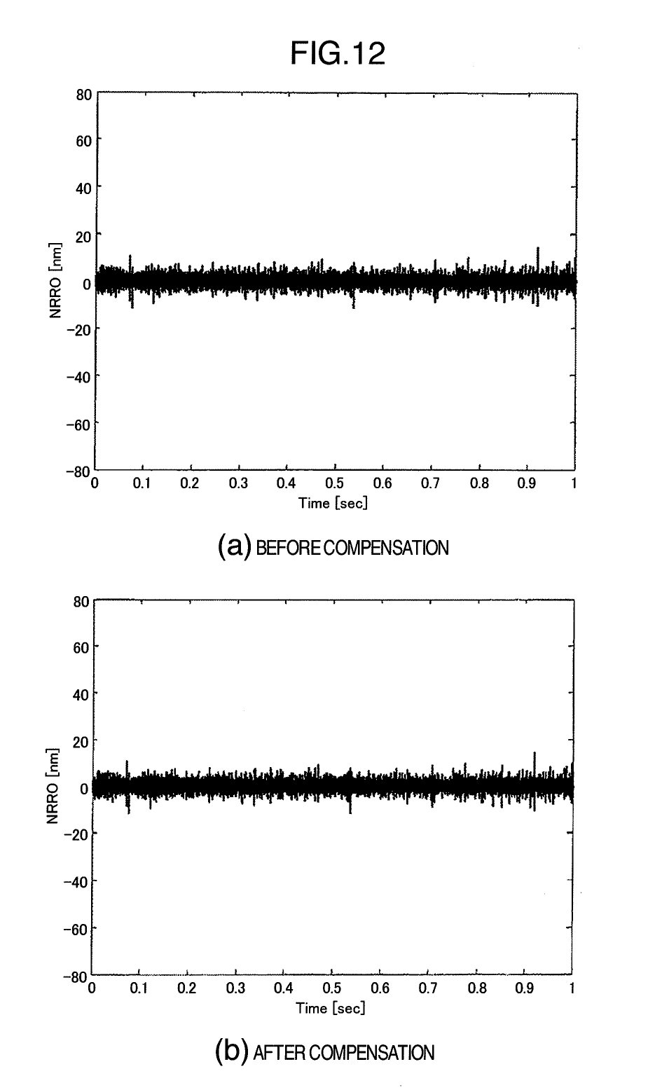

These values stored in the RAM 82 are iteratively used to control the magnetic head 61 so that the PES can be made to fall within the target range of ±25 nm as shown in FIG. 10. In addition, as shown in FIGS. 11 and 12, the RRO can be reduced without increasing NRRO. This in turn makes it possible to eliminate the time required for the resonance filter 70 to go into a steady state and to obtain results equivalent to those of the feedback control using the resonance filter 70.

In cases where there is a limit to the number of filters and the resulting RRO suppression effect is insufficient, a couple of methods may be conceived: a method for optimizing the correction value by repetitive execution of the processing from Step 2 to Step 7; and a method for performing conventional feedforward control after having calculated the correction value as stated previously. In the former method, after the processing from Step 2 to Step 7 has been performed, an output value of the resonance filter 70 at that time is stored by the DSP 80 in the RAM 82. And next, when determining the RRO to be suppressed component at Step 2, the DSP 80 sequentially selects the largest-amplitude one of RRO components other than the RRO components that have already been set up to the resonance filter 70. And, when storing in the RAM 82 an output value of the resonance filter 70′ to be newly set up at Step 7, the DSP 80 adds the correction value that has already been stored in the RAM 82 and newly stores it in the RAM 82. When adding, the DSP 80 calculates a least common multiple of the order of the correction value that has already been stored in the RAM 82 and the order of a correction value newly output from the resonance filter 70′, and then adds both of the correction values in such region. Additionally, in the state that the output value of the resonance filter 70 that has already been stored in the RAM 82 is iteratively used as the correction value, the DSP 80 calculates an internal state variable of the filter until the resonance filter 70′ newly goes into a steady state.

In the latter method, the processing is performed from Step 2 to Step 7 and, when storing output values of the resonance filter 70 in the RAM 82, the DSP 80 stores the output values during one rotation of the disk but not a least common multiple of the order of resonance filter 70 being set up in the RAM 82. Then, the DSP 80 calculates a feedforward control input value based on a target value to be generated from the RRO obtained while using as a correction value the output value of the resonance filter 70 stored in the RAM 82 and inverse models of controlled objects such as the magnetic head 61 or VCM 62. Then, the DSP 80 adds the output value of the resonance filter 70 stored in the RAM 82 and the feedforward control input value, and newly stores it in the RAM 82 as a correction value. At this time, both of the output values of resonance filter 70 and the feedforward control input values are data during one rotation of the disk.

Further, in cases where there is a sufficient correlation in RRO components between respective tracks, a process of grasping regions with such correlation is provided. The DSP 80 extracts RRO components from PES of an entire region of the disk calculated by the DSP 80 at Step 1. The DSP 80 calculates the average of RRO components of respective tracks and, if this average occupies a certain percentage (e.g., 90% or more) of the RRO components, judges that there is a correlation therebetween. In the regions with this correlation, common correction values are usable, and so the DSP 80 associate track numbers of such RRO component-correlated regions with common correction values and stores them in the RAM 82. With this method, it becomes possible to omit some correction values to be stored in the RAM 82, thus leading to improvement in performance of the HDD 100.

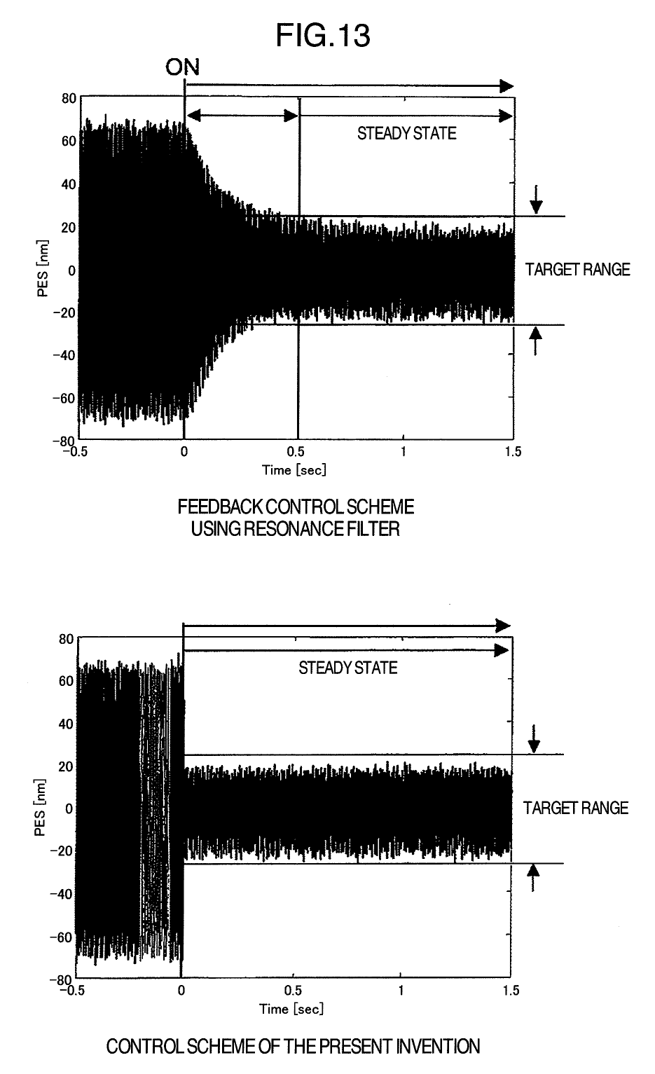

FIG. 13 compares the feedback control using a conventional resonance filter with the target control of the present invention, regarding the time necessary to suppress a specific frequency component from RRO and to reach the control for causing PES to fall within the range of ±25 nm. In the conventional scheme, the target PES is reached 0.5 seconds after the start of the control by means of the resonance filter at 0 sec. This is equivalent to 50 rotations as a rotation number. More specifically, every time the magnetic recording is performed, a learning time of 50 rotations is needed. This poses an extensive damage in the HDD 100 that is nowadays required to provide high-speed data transmission. Further, the higher the density becomes, the narrower the target range of the PES becomes. It is thus predicted that the increase of RRO components to be suppressed along with this requires more learning time and deteriorates the performance. On the other hand, the present invention can successfully control PES to stay within the target range of the PES immediately after the start of the control at 0 sec. In other words, it is apparently possible to obtain control effects equivalent to those of the feedback control using a resonance filter, without the resonance filter's learning time.

It should be noted that the patterned (recording) medium of the above embodiment may be a discrete recording medium (DTM) with separated data tracks being made by patterning a magnetic layer or a bit-patterned recording medium (BPM) with separated data tracks and bits. It should be noted that the present invention may be applicable to not only the patterned recording media or discrete recording media but also media which are not patterned but necessary to suppress all repeatable runout in order to hold the head over a specific region when recording for certain reasons.

In addition, it is needles to say that the present invention is applicable not only to hard disk devices but also to optical disk devices, magnetooptical disk devices, etc. if it is necessary to suppress all repeatable runout for certain reasons.

### INDUSTRIAL APPLICABILITY

The present invention relates to a method for controlling a head position over recording media which are necessary to reduce repeatable runout (RRO) within a wide range from a low frequency band to a high frequency band, e.g., discrete recording media, and is applicable to such recording media.

### REFERENCE SIGNS LIST

1 . . . Recording Medium, 2A, 2B . . . Underlayer, 3A, 3B . . . Recording Layer, 4A . . . Mask Layer, 5A . . . Resist, 10 . . . Substrate, 10A, 10B . . . Face, 11 . . . User Data Area, 12 . . . Servo Area, 20 . . . Read/Write Preamplifier, 30 . . . Read/Write Channel, 40 . . . Hard Disk Controller (HDC), 50 . . . Servo Pattern, 51 . . . Preamble, 52 . . . Address, 53 . . . Burst, 54 . . . Postamble, 61 . . . Magnetic Head, 62 . . . Voice Coil Motor (VCM), 70 . . . Resonance Filter, 80 . . . DSP, 81 . . . Read-Only Memory (ROM), 82 . . . Random Access Memory (RAM), 91 . . . VCM Driver, 92 . . . SPM Driver, 93 . . . Digital-to-Analog Converter (D/A), 94 . . . Servo Controller, 100 . . . Hard Disk Drive (HDD).

1. A position control method comprising:
selecting a repeatable runout to be suppressed of a rotational recording medium;
compensating the repeatable runout to be suppressed using a resonance filter;
storing an output value of the resonance filter compensating the repeatable runout; and
using the stored value as a control input for head positioning over the rotational recording medium.

2. The position control method according to claim 1, further comprising:
selecting, after having stored the output value, a second repeatable runout different from the repeatable runout;
compensating the second repeatable runout using the resonance filter;
storing a second output value of the resonance filter compensating the second repeatable runout; and
using a value obtained by adding respective stored output values as a control input for head positioning over the rotational recording medium.

3. The position control method according to claim 2, wherein
by, when storing the second output value, storing a value obtained by adding it to the already stored output value, a value obtained by adding respective output values is used as a control input for head positioning over the rotational recording medium.

4. The position control method according to claim 1, wherein
the resonance filter is a filter of a head positioning control system with a vector locus of open-loop transfer characteristics at a rotation frequency of the rotational recording medium going in a direction away from (−1, 0).

5. The position control method according to claim 1, wherein
the resonance filter has resonance characteristics only at an integral multiple of the rotation frequency of the rotational recording medium.

6. The position control method according to claim 1, wherein
the resonance filter is a resonance filter group comprising a plurality of resonance filters corresponding to different repeatable runout respectively.

7. The position control method according to claim 6, wherein
the repeatable runout to be suppressed is selected in descending order of amplitude of repeatable runout up to the number of the resonance filters.

8. The position control method according to claim 6, wherein
a value obtained by adding respective output values of the plurality of resonance filters is stored.

9. The position control method according to claim 1, wherein
an output value of the resonance filter compensating the repeatable runout is stored during one rotation of the rotational recording medium.

10. The position control method according to claim 6, wherein
output values of the respective resonance filters compensating the repeatable runout are stored during one rotation of the rotational recording medium, or the number of output values equivalent to a least common multiple of orders of the respective resonance filters are stored.

11. The position control method according to claim 1, further comprising:
calculating a feedforward control input value based on a target value to be generated from the repeatable runout after having used the stored output value as a control input for head positioning over the rotational recording medium and an inverse model of a controlled object;
storing a value obtained by adding the output value and the feedforward control value; and
using this value as the control input for head positioning over the rotational recording medium.

12. A disk device comprising:
a rotational recording medium for storing information;
a head for writing/reading information to/from this medium;
a memory for storing an output value of a resonance filter compensating the repeatable runout, the resonance filter adapted for the repeatable runout to be suppressed of the medium being used; and
a processing device which uses the value stored in this memory as a control input for head positioning over the medium.

13. The disk device according to claim 12, wherein
the resonance filter is a filter of a head positioning control system with a vector locus of open-loop transfer characteristics at a rotation frequency of the rotational recording medium going in a direction away from (−1, 0).

14. The disk device according to claim 12, wherein
the resonance filter has resonance characteristics only at an integral multiple of the rotation frequency of the medium.

15. The disk device according to claim 14, wherein
the resonance filter is a resonance filter group comprising a plurality of resonance filters corresponding to different repeatable runout respectively, and
the processing device sequentially selects repeatable runout to be suppressed in descending order of amplitude up to the number of the resonance filters.

16. The disk device according to claim 12, wherein
the memory stores an output value of the resonance filter compensating the repeatable runout during one rotation of the medium.

17. The disk device according to claim 15, wherein
the memory stores a value obtained by adding output values of the respective resonance filters compensating the repeatable runout during one rotation of the medium, or the number of values equivalent to a least common multiple of orders of the respective resonance filters.

18. The disk device according to claim 12, wherein
the processing device newly stores in the memory both the value stored in the memory and a value obtained by adding a target value to be generated from the repeatable runout after having used this value as a control input for head positioning over the medium and a feedforward control input value based on an inverse model of a controlled object, and uses this newly stored values as a control input for head positioning over the rotational recording medium.

19. The disk device according to claim 12, wherein
the memory is the rotational recording medium.

20. The disk device according to claim 12, wherein
the rotational recording medium is either a discrete recording medium with separated data tracks or a bit-patterned recording medium with separated data tracks and bits.
